(19) United States
(12) Patent Application Publication
(10) Pub. No.: US 2012/0164203 A1
(43) Pub. Date: Jun. 28, 2012

(54) PROCESS FOR PREPARATION OF STABLE, MICROENCAPSULATED AND SUSTAINED RELEASE BIOCIDAL ACTIVES AND COMPOSITION THEREOF

(76) Inventors: Raman Premachandran, Saddle Brook, NJ (US); Kolazi S. Narayanan, Wayne, NJ (US); Blanca Gomez, Phillipsburg, NJ (US); Karen Winkowski, Springfield, NJ (US); Daniel H. Brown, Carteret, NJ (US)

(21) Appl. No.: 13/378,397

(22) PCT Filed: Jun. 17, 2010
(86) PCT No.: PCT/US10/38925

§ 371 Date: Mar. 16, 2012

Related U.S. Application Data
(60) Provisional application No. 61/187,827, filed on Jun. 17, 2009.

(51) Int. Cl. A01N 25/34; B05D 5/00

(52) U.S. Cl. 424/408; 427/2.21

(57) ABSTRACT

Disclosed herein is a process for the preparation of a stable sustained-release biocidal composition containing microencapsulated biocide and wherein the process comprises the steps of: (i) adsorbing the biocide onto an inert carrier by grinding to attain the required particle size and wherein the ratio of biocide; inert carrier is in the range of about 1:99 to about 99:1 (ii) optionally coating with an appropriate amine or imine compound or a water resistant film forming polymer and dispersing the resultant biocide encapsulated inert carrier in an aqueous medium in the presence of suitable dispersing agent (iii) adding at least one thickening agent to re-disperse the encapsulated biocide containing partial amount of non-encapsulated biocide if any and (iv) preparing an aqueous or solvent based sustained release biocide dispersion. Also disclosed is a stable, sustained-release biocidal composition prepared by such process and uses thereof.

### FIELD OF THE INVENTION

The present invention relates generally to a biocidal composition. It also relates to a process for preparing stable, sustained-release biocidal compositions containing microencapsulated biocides.

### BACKGROUND OF THE INVENTION

Various compositions of biocides are traditionally used as herbicide, fungicide, pesticide, and antifouling agents, in addition to several other systems that necessitate the control or inhibition of microbial growth.

The ability to prolong the discharge of the biocidal content at their site of action has always been an important task in the field of biocide delivery systems. In general, when a biocidal compound is applied at the site of action, the compound is rapidly released whether or not it is required. Controlled release or sustained release compositions deliver the biocidal compound in a manner that more specifically matches the need for the compound. In this fashion, only the required amount of the biocidal content is discharged at the site of action where the protection is necessary. Further, prolonged release of the active content at the site of action offers the advantages of reduced cost, lowered toxicity and increased efficiency.

Various attempts to regulate the release of biocide to inhibit microbial growth have been of interest to the researchers around the globe. The sol-gel technology to entrap the biocidal content and to allow their release by diffusion method from the hydrogel set-up is very well explored in the prior arts such as EP-A0602810, EP-A0736249, GB-A2235462 and U.S. Pat. No. 5,229,124.

Another approach to regulate the delivery of biocide is encapsulating them in a suitable polymer network employing various techniques such as spray drying, interfacial polycondensation and disclosed in U.S. Pat. Nos. 4,360,376, 4,417,916, 4,563,212, 3,429,827, 3,577,515, 3,959,464, 4,640,709, 4,244,836, 4,286,020 4,353,962, 4,690,786, 5,073,191, 5,277,979, 6,656,508 incorporated herein by reference.

U.S. Pat. No. 4,579,779 issued to Freund Industrial Co., Ltd. incorporated herein by reference, describes encapsulation of organic liquids such as perfumes, food flavors, pesticides and fungicides, wherein, amorphous silica particles were encapsulated with volatile organic liquids and are allowed to release the vapors over a period of time. U.S. Pat. No. 4,552,591 discloses a composition made of impregnated mineral particles with biocides comprising a liquid biocide adsorbed on to a granular or bead-like mineral adsorbents availed from nature for the use of oil field water treatment. In similar lines, the use of particulate carriers such as calcium carbonate, dolomite, gypsum, and limestone are disclosed in U.S. Pat. Nos. 4,015,973, 4,954,134, 5,078,799, 5,242,690 and 6,613,138 for delivering active ingredients therein.

Despite these innovations, there remains a need for a composition that regulates the discharge or release of the biocidal content with controlled leaching ability of the integrated biocidal content at the site of action is essential to improve the environmental concerns with reduced toxic profiles in all its applications. Hence, the problem addressed by the present invention is to provide a stable biocidal dispersion which is able to deliver the biocidal content in sustained release fashion.

### SUMMARY OF THE INVENTION

It has been discovered that active-ingredient compositions exhibiting regulated release profiles are provided by intimately comingling the active ingredient with selected inorganic carriers. Such compositions display controlled, delayed, extended, maintained, slowed, and/or sustained release relative to untreated active.

Additionally, it is an object of the present invention to provide a method for producing these compositions, wherein at least one active ingredient is intimately comingled with at least one carrier capable of providing regulated release. In one embodiment, the comingling step comprises triturating, grinding, milling (or similar methods) at least one active ingredient with at least one such carrier.

In a preferred embodiment, the active ingredient is a biocide and wherein one or more biocides or an appropriate mixture is employed to prepare the aqueous or solvent based biocidal dispersion.

In another embodiment, coated compositions are provided, wherein a water-resistant coating is applied to a first composition comprising an active ingredient and a carrier capable of providing regulated aqueous or solvent release. Among other benefits, such coated compositions possess formulation flexibility to further regulate the release of the active ingredient, especially to reduce the release during subsequent aqueous-phase processing step(s).

In accordance with yet another aspect of the present invention, there is provided a process for the preparation of stable, sustained-release biocide compositions employing water soluble, sparingly water soluble, water insoluble and/or hydrolysis-sensitive biocidal compounds.

In accordance with still another aspect of the present invention, there is provided a process for the preparation of stable, sustained-release aqueous or solvent biocidal dispersions, wherein the process comprises adsorbing the biocide onto an inert carrier in a ratio of 1:99 to 99:1.

In accordance with a further aspect of the present invention, the stable, sustained-release biocide compositions prepared according to the above process is employed in the field of agriculture, health, pharmaceutical, paint, homecare, personal care, metal working fluids, oilfield and/or wood treatment.

In accordance with one preferred aspect of the present invention, the composition of stable, sustained-release biocide dispersion comprises:
i. a biocide adsorbed inert carrier, optionally coated with tertiary amine for hydrolysis sensitive biocides;
ii. a dispersant;
iii. a thickening agent to re-disperse the encapsulated biocide/s containing non-encapsulated biocide/s if any; and
iv. an aqueous or solvent medium to disperse the resultant encapsulated biocide.

In accordance with one another aspect of the present invention, the composition of stable, sustained-release biocides is able to deliver the biocide content in sustained-release manner at the site of action required.

### DETAILED DESCRIPTION OF THE INVENTION

While this specification concludes with claims particularly pointing out and distinctly claiming that, which is regarded as the invention it is anticipated that the invention can be more readily understood through reading the following detailed description of the invention and study of the included examples.

The open-ended claim “Comprising” and “Comprises of” encompasses the more restrictive close-ended claims such as “Consisting essentially of” and “Consisting of”.

All percentages, parts, proportions and ratios as used herein, are by weight of the total composition, unless otherwise specified. All such weights as they pertain to listed ingredients are based on the active level and, therefore; do not include solvents or by-products that may be included in commercially available materials, unless otherwise specified.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

All references to singular characteristics or limitations of the present invention shall include the corresponding plural characteristic or limitation, and vice versa, unless otherwise specified or dearly implied to the contrary by the context in which the reference is made.

The term “about” can indicate a variation of 10 percent of the value specified; for example about 50 percent carries a variation from 45 to 55 percent. For integer ranges, the term about can include one or two integers greater than and less than a recited integer.

The present invention provides a process for preparing stable, microencapsulated aqueous or solvent biocidal dispersion, and compositions thereof.

The term “biocide” as used herein is to be understood to refer to agents such as germicides, bactericides, fungicides, algicides, aquaticides, herbicides, insecticides, larvicides, pesticides, rodenticides, taeniacides, plant growth regulators and the like, which are used for their ability to inhibit growth of and/or destroy biological and/or microbiological species such as bacteria, fungi, algae, caterpillar, insects, larvae, mildew, rodents, spider, worm and the like.

In a particular embodiment of the present invention, the suitable biocide employed to prepare the aqueous or solvent biocidal dispersion would include but are not limited to 3-allyloxy-1,2-benzoisothiazol-1,1-dioxide; basic copper chloride; basic copper sulfate; 1,2-benzisothiazoline-3-one; 2-Methyl-4-sothiazoline-3-one; methyl-N-(1H-benzoimidazol-2-yl)carbamate; 2-(tert-butylamino)-4-(cyclopropylatnino)-6-(methylthio)-s-triazine; 2-tert-butylamino-4-ethylamino-6-methylmercapto-s-triazine; S—N-butyl-5′-para-tert-butylbenzyl-N-3-pyridyldithiocarbonylimidate; 2-chloro-1-(3-ethoxy-4-nitrophenoxy)-4-(trifluoromethyl)benzene; 4-chlorophenoxy-3,3-dimethyl-1-(1H,1,3,4-triazol-1-yl)-2-butanone; α-[2-(4-chlorophenyl)ethyl]-α-(1,1-dimethylethyl)-1H-1,2,4-triazole-1-ethanol; copper 8-quinolinate; cycloheximide; bis-(dimethyldithiocarbamoyl)disulfide; 11-dehydrodibenzo(b,f)azepine; 2,4-dichloro-6-(0-chloroanilino)-1,3,5-triazine; 1,4-dichloro-2,5-dimethoxybenzene; N′-dichlorofluoromethylthio-N,N-dimethyl-N-phenyl sulfamide; 2,3-dichloro-1,4-naphthoquinone; 2,6-dichloro-4-nitroaniline; 4,5-dichloro-2-N-octyl-4-isothiazolin-3-one; N-(3,5-diehlorophenyl)-1,2-dimethylcyclopropane-1,2-dicarboxyimide; N′-(3,4-dichlorophenyl)-N,N-dimethylurea; 1-[2-(2,4-dichlorophenyl)-4-ethyl-1,3-dioxorane-2-ylmethyl]-1H,1,2,4-triazol; N-(3,5-dichlorophenyl)succinamide; 1-[[2(2,4-d chlorophenyl)-4-propyl-1,3-dioxolan-2-yl]methyl]1-H-1,2,4-triazole; N-2,3-dichlorophenyltetrachlorophthalamic acid; 3-(3,5-dichlorophenyl)5-ethenyl5-methyloxazolizine-2,4-dione; 2,3-dicyano-1,4-dithioanthraquinone; N-(2,6-diethylphertyl)-4-methylphthalimide; N-(2,6-α-diethylphenyl)phthalimide; 5,6-dihydro-2-methyl-1,4-oxathine-3-carboxanilide; 5,6-dihydro-2-methyl-1,4-oxathine-3-carboxanilido-4,4-dioxide; diisopropyl 1,3-dithiolane-2-iridene malonate; N,N-diisopropyl S-benzylphosphorothioate; 2-dimethylamino-4-methyl-5-N-butyl-6-hydroxypyrimidine; diethyl 2-dimethoxyphosphinothioylsulfanylbutanedioate; his-(dimethyldithiocarbamoyl)ethylenediamine; 5-ethoxy-3-trichloromethyl-1,2,4-thiaziazole; ethyl-N-(3-dimethylaminopropyl)thiocarbamate hydrochloride; O-ethyl S,S-diphenyldithiophosphate; 3,3′-ethylene-bis-(tetrahydro-4,6-dimethyl-2H-1,3,5-thiadiazine-2-thione); 3-hydroxy-5-methylisooxazole; 3-iodo-2-propargyl butyl carbamate; iron methanearsonate; 3′-isopropoxy-2-methylbenzanilide; 1-isopropylcarbamoyl-3-(3,5-dichlorophenyl)hydantoin; kasugamycin; manganese ethylene-bis-(dithiocarbamate); 1,2-bis-(3-methoxyearbon yl-2-thioureido) benzene; methyl-1(butylcarbamoyl)-2-benzimidazolecarbamate; 5-methyl-10-butoxycarbonylamino-10; 3-methyl-4-chlorobenzthiazol-2-one; methyl-D,L-N-(2,6-dimethylphenyl)-N-(2′-methoxyacetyl)alaninate; S,S-6-methylquinoxaline-2,3-di-yldithiocarbonate 5-methyl-s-triazol-(3,4-b)benzthiazole; nickel dimethyldithiocarbamate; 2-octyl-2H-isothiazol-3-one; 2-oxy-3-chloro-1,4-naphthoquinone copper sulfate; pentachloronitrobenzene; (3-phenoxyphenyl)methyl(+/−)-cis,trans-3-(2,2-dichloroethenyl)-2,2-dimethylcyclopropane-carboxylate; polyoxine; potassium N-hydroxymethyl-N-methyldithiocarbamate; N-propyl-N-[2-(2,4,6-trichlorophenoxy)ethyl]imidazol-1-carboxamide; 2-pyridinethiol-1-oxide sodium salt; sodium pyrithione; N-tetrachloroethylthio-4-cyclohexene-1,2-dicarboxyimide; tetrachloroisophthalonitrile; 4,5,6,7-tetrachlorophthalide; 1,2,5,6-tetrahydro-4H-pyrrolol-[3,2,1-i,j]quinoline-2-one; 2-(thiocyanomethylthio)benzothiazole; N-trichloromethylthio 4-cyclohexene-1,2-dicarboxylmide; silver; copper; N-(trichloromethylthio)phthalimide; validamycin; zinc ethylene-bis-(dithiocarbamate); zinc bis-(1-hydroxy-2(1H)pyridinethionate; zinc propylene-bis-(dithiocarbamate); and zinc pyrithione.

According to the present invention, the plant growth regulators employed include organic and inorganic fertilizers and contain micro and macronutrients such as ammonium nitrate, ammonium sulfate and compounds containing magnesium, nitrogen, phosphorus, and potassium. The representative plant growth regulators are selected from the group consisting of but are not limited to N-methoxycarbonyl-N′-4-methylphenylcarbamoylethylisourea and 1-(4-chlorophenylcarbamoyl)-3-ethoxycarbonyl-2-methylisourea; another type of plant growth regulators such as sodium naphthaleneacetate, 1,2-dihydropyridazine-3,6-dione and gibberellins; triazine herbicides such as 2-methylthio-4,6-bisethylamino-1,3,5-triazine, 2-chloro-4,6-bisethylamino-1,3,5-triazine, 2-methoxy-4-ethylamino-6-isopropylamino-1,3,5-triazine, 2-chloro-4-ethylamino-6-isopropylamino-s-triazine, 2-methylthio-4,6-bis(isopropylamino)-S-triazine and 2-methylthio-4-ethylamino-6-isopropylamino-s-triazine; phenoxy herbicides such as 2,4-dichlorophenoxyacetic acid and methyl, ethyl, and butyl esters thereof. 2-chloro-4-methylphenoxyacetic acid, 4-chloro-2-methylphenoxyacetic acid and ethyl 2-methyl-4-chlorophenoxybutylate; diphenylether herbicides such as 2,4,6-trichlorophenyl-4′-nitrophenylether,2,4-dichlorophen yl-4′-nitrophenylether and 3,5-dimethylphenyl-4′-nitrophenylether; urea herbicides such as 3-(3,4-dichlorophenyl)-1-methoxy-1-methyl urea, 3-(3,4-dichlorophenyl)-1,1-dimethylurea and 3-(4-chlorophenyl)-1,1-dimethyl urea; carbamate herbicides such as 3-methoxycarbonylaminophenyl-N-(3-methylphenyl)carbamate, isopropyl-N-(3-chlorophenyl)carbamate and methyl-N-(3,4′-dichlorophenyl)carbamate; uracil herbicides such as 5-bromo-3-sec-butyl-methyluracil and 1-cyclohexyl-3,5-propyleneuracil; thiolcarbamate herbicides such as S-(4-chlorobenzyl)-N,N-diethylthiolcarbamate,S-ethyl-N-cyclo hexyl-N-ethylthiolcarbamate and S-ethyl-hexahydro-1H-azepine-1-carbothioate and S-ethyl-N,N-di-n-propyl-thiocarbamate; pyridinium herbicides such as 1,1′-di-methyl-4,4′-bispyridinium dichloride; phosphoric herbicides such as N-(phosphonomethyl)glycine; aniline herbicides such as alpha-trifluoro-2,6-dinitro-N,N-dipropyl-p-toluidine, 4-(methylsulfonyl)-2,6-dinitro-N,N-dipropylaniline and N[3], N[3]-diethyl-2,4-dinitro-6-trifluoromethyl-1,3-phenylene diamine; acid anilide herbicides such as 2-chloro-2′,6′-diethyl-N-(butoxymethyl)acetoanilide, 2-chloro-2′,6′-diethyl-N-(methoxymethyl)acetoanilide, and 3,4-dichloropropionanilide; pyrazole herbicides such as 1,3-dimethyl-4-(2,4-diehlorobenzoyl)-5-hydroxypyrazole and 1,3-di-methyl-4-(2,4-dichlorobenzoyl)-5-(p-toluenesulfonyloxy)pyrazole; 5-tert-butyl-3-(2,4-dichloro-5-isopropoxyphenyl)-1,3,4-oxadiazoline-2-one; 2-[N-isopropyl, N-(4-chlorophenyl)carbamoyl]-4-chloro-5-methyl-4-isooxazoline-3-one; 3-isopropylbenzo-2-thia-1,3-diazinone-(4)-2,4-dioxide and 3-(2-methyl-phenoxy)pyridazine.

The examples of herbicides comprise 5-bromo-3-sec-butyl-6-methyluracil; 5-tert-butyl-3-(2,4-dichloro-5-isopropoxyphenyl)-1,3,4-oxadiazoline-2-one; S-(4-chlorobenzyl)-N,N-diethylthiolcarbamate; 2-chloro-4,6-bisethylamino-1,3,5-triazine; 2-chloro-2′,6′-diethyl-N-(butoxymethyl)acetoanilide; 2-chloro-2′,6′-diethyl-N-(methoxymethyl)acetoanilide; 2-chloro-4-ethylamino-6-isopropylamino-s-triazine; 2-chloro-4-methylphenoxyacetic acid; 4-chloro-2-methylphenoxyacetic acid; 3-(4-chlorophenyl)-1,1-dimethyl urea; 1-cyclohexyl-3,5-propyleneuracil; 2,4-dichlorophenoxyacetic acid, and methyl-, ethyl-, and butyl-esters thereof; 3-(3,4-dichlorophenyl)-1,1-dimethylurea; 3-(3,4-dichlorophenyl)-1-methoxy-1-methyl urea; 2,4-dichlorophenyl-4′-nitrophenylether; 3,4-dichloropropioneanilide; N[3],N-[3]-diethyl-2,4-dinitro-6trifluoromethyl-1,3-phenylene diamine; 1,1′-di-methyl-4,4′-bispyridinium dichloride; 1,3-dimethyl-4-(2,4-dichlorobenzoyl)-5-hydroxypyrazole; 1,3-dimethyl-4-(2,4-d chlorobenzoyl)-5-(p-toluenesulfonyloxy)pyrazole; 3,5-dimethylphenyl-4′-nitrophenylether; diphenylether ethyl 2-methyl-4-chlorophenoxybutylate; S-ethyl-N-cyclohexyl-N-ethylthiolcarbamate; S-ethyl-hexahydro-1H-azepine-1-carbothioate; S-ethyl-N,N-di-N-propyl-thiocarbamate; 3-isopropylbenzo-2-thia-1,3-diazinone-(4)-2,4-dioxide; 2-[N-isopropyl,N-(4-chlorophenyl)carbamoyl]-4-chloro-5-methyl-4-isooxazoline-3-one; isopropyl-N-(3-chlorophenyl)carbamate; 3-methoxycarbonylaminophenyl-N-(3-methylphenyl)carbamate; 2-methoxy-4-ethylamino-6-isopropylamino-1,3,5-triazine; methyl-N-(3,4′-dichlorophenyl)carbamate; 3-(2-methyl-phenoxy)pyridazine-4-(methylsulfonyl)-2,6-dinitro-/V,N-dipropylaniline; 2-methylthio-4,6-bisethylamino-1,3,5-triazine; 2-methylthio-4-ethylamino-6-isopropylamino-s-triazine; 2-methylthio-4,6-bis-(isopropylamino)-S-triazine; N-(phosphonomethyl)glycine; 2,4,6-trichlorophenyl-4-nitrophenylether; and trifluoro-2,6-dinitro-N,N-dipropyl-p-toluidine.

The present invention employs sparingly water soluble, water insoluble and/or hydrolysis-sensitive biocidal compounds. According to the present invention, the biocidal compounds which exhibit favorable water solubility are suitable for the sustained release of those compounds. The composition and methods of these biocidal compounds provides reduced rate of dissolution and/or leaching at their site of action. Based on their solubility in pure water at 25° C. and near atmospheric pressure, suitable biocidal compounds which exhibit the solubility 100 mg/L or more are identified from the known art for producing the aqueous or solvent biocidal dispersion. Examples of suitable biocides that meet this criterion of water solubility comprise terbutryn, tebuconazole, diuron, propiconazole, 3-iodo-2-propargyl butyl carbamate, cabendazim, 2-octyl-2H-isothiazol-3-one.

According to one important embodiment of the present invention, the biocidal dispersion composition is prepared by employing an appropriate solvent system, wherein the solvent is preferably aqueous or non-aqueous in nature. The non-limiting examples of non-aqueous solvent are selected from the group consisting of polyglycol, polyether, polyol, mineral oil, plasticizer pthalates and/or alkyd resins.

Without being bound to the theory, the particle size of the biocide and carrier are believed to be important in producing the sustain-release biocide composition containing microencapsulated biocide and is achieved by the appropriate methods known in the art.

The adsorption of biocide onto the desired carrier is enabled by intimate comingling, wherein the biocide comes into intimate contact with carrier particles. The reduced particle size and intimate comingling are preferably achieved by triturating, grinding, milling, blending and other related methods. In one preferred embodiment, at least one active and one carrier are intimately comingled through triturating, grinding or milling method and less preferably, the active and a carrier are triturated, milled or ground separately, and then comingled. After completion of intimate comingling, the blend of biocide and carrier is subjected to particle size reduction by the methods known in the art in order to achieve the particle size of less than about 0.5 μm to about 10.0 μm and preferably about 0.5 μm to about 3.0 μm.

Various inorganic carrier particles are employed for the adsorption of biocide are selected from the group comprising silicate, aluminosilicates, expanded perlite, zeolite and diatomaceous earth materials. The preferred silicates are oxidized silicon compounds such as SiO₃, SiO₄, Si₂O₆ and Si₂O₇. The zeolite can be microphorous aluminosilicate minerals comprised of analcime, barrerite, bellbergite, bikitaite, boggsite, brewsterite, chabazite, clinoptilolite, cowlesite, dachiardite, edingtonite, epistilbite, erionite, faujasite, ferrierite, garronite, gismondine, gmelinite, gobbinsite, gonnardite, goosecreekite, harmotome, herschelite, heulandite, laumontite, levyne, maricopaite, mazzite, merlinoite, mesolite, montesommaite, mordenite, matrolite, mffietite, paranatrolite, paulingite, pentasil, perlialite, phillipsite, pollucite, scolecite, sodium dachiardite, stellerite, stilbite, tetranatrolite, thomsonite, tschernichite, wairakite, wellsite, willhendersonite, and yugawaralite. Specific aluminosilicate compounds are kaolin and smectite. However, preferred carrier particles include perlite and expanded-perlite. These are preferred due to their low density, high porosity, low thermal conductivity, fire resistant characteristic and their ability to provide strength to the materials added.

The inorganic carrier particles employed herein have a micropore system. As per IUPC, a micropore is one having a diameter of not more than 30AU, wherein the activation is normally being attained by thermal action. Further, to avail appropriate retention of biocide, a desired inorganic carrier particle has a BET surface area of at least from about 2 m²/g to about 200 m²/g.

The biocide is integrated onto a selected inert carrier material to provide a device for sustained release of the desired biocidal compound over an extended period of time following incorporation or application to another object or substance. By employing said carrier materials, one is capable to attain a sustained release over an extended period of time regardless of washing of the object or wearing away of the immediate surface. Simultaneously, the selection of suitable carrier material ensures that the integrated biocidal compound is discharged in a sustained release fashion over a desired period of time. The selection of carrier in the present invention is based on the presence of non-adsorbed biocidal compound left in the formulated biocidal dispersion composition. A process for estimating whether a particular carrier is suitable for a selected biocide is (i) filtering a prepared biocidal dispersion to separate the aqueous or organic solvent solution containing non-adsorbed biocidal content and biocide adsorbed carrier; (ii) determining the presence of non-adsorbed biocidal content in the separated aqueous or organic solution by a suitable analytical method; (iii) determining the difference between the total amount of the active adsorbed to the given weight of the carrier and the leaching rate of biocide in to the aqueous or organic solution.

The ratio of biocide:carrier is based on the ability of a biocide dischargeable from the biocide adsorbed carrier present in aqueous or solvent biocidal dispersion composition on sustained-release manner in an adequately affective amount to combat the bacterial or fungal growth at their site of action and wherein the ratio of biocide:carrier is from about 1% biocide to about 99% carriers to about 99% biocide to about 1% active. The preferable ratio of biocide:carrier are (i) about 10% biocide:about 90% carrier; (ii) about 20% biocide:about 80% carrier; (iii) about 30% biocide:about 70% carrier; (iv) about 40% biocide:about 60% carrier; (v) about 50% biocide:about 50% carrier; (vi) about 60% biocide:about 40% carrier; (vii) about 70% biocide:about 30% carrier; (viii) about 80% biocide:about 20% carrier; (ix) about 90% biocide:about 10% carrier and so on.

The evaluation of sustained release of biocidal content from the aqueous or solvent biocidal dispersion composition is confirmed by leaching method according to ASTM D5590, i.e., “Determining the resistance of paint films and related coatings to fungal defacement by accelerated four-week agar plate assay” which is incorporated in its entirety by reference. For the evaluation of biocidal activity, the aqueous or solvent biocidal dispersion composition is incorporated into an application object and mixed thoroughly until it becomes homogenous; preferably an exemplifying paint formulation is selected. The biocidal activity of composition containing paint formulation is evaluated by leaching method and wherein paint samples were casted as a film. The film strip is leached with distilled water for 24, 48 and 72 hrs. The leached film strips are screened through zone of inhibition method for their antibacterial and antifungal activity using solidified malt agar as a medium for inoculation, and wherein, the gram (+) and gram (−) bacterial strains and various other fungal strains are employed. The preferable fungal strains would include but are not limited to Aspergillus Niger (ATCC 6275), Penicillium funiculosum (ATCC 11797), Aureobasidiuni Pullulans (ATCC 9348) with the concentration range of about 10⁷ spores/mL and the preferable bacterial strains comprises of Escherichia coli (ATCC 11229) and Staphylococcus aureus (ATCC 6538). Based on the zone of inhibition results obtained from the representative antifungal and antibacterial activity, the carrier is chosen.

In one embodiment of the present invention the biocide is optionally coated with an appropriate amine or imine compound or a water resistant film forming polymer to provide resistance to hydrolysis sensitive biocidal compounds adsorbed on to the inert carrier particle. The suitable amine compounds would include but are not limited to primary, secondary, tertiary and polyamines. The preferable amine employed in the present invention is selected from the group comprising Armeen CD, Armeen OD, Armeen TD, Armeen HT Flake, Armeen 8D, Armeen 12D, Armeen 14D, Armeen 16D, Armeen 18D, Armeen 2C, Armeen 2HT, N,N-Dimethyl-1-octadecanamine, Armeen DMMCD, Armeen DMTD, Armeen DM12D, Armeen DM14D, Armeen DM16D, Armeen DM18D, Armeen DM22D, Armeen M2HT, and Armeen M20. The polyamine, particularly a polyamide of a fatty acid dimer or the polyamide sold under the Trademark “Santiciser”. Most preferably, tertiary amines are employed for the coating of hydrolysis sensitive compounds.

One feature of the present invention is to coat the biocide adsorbed inert carrier with water resistant or water insoluble film forming polymers that are known in the prior-art to prevent the degradation of hydrolysis-sensitive biocidal compounds If they are part of the composition. The water-resistant or water insoluble film forming polymers would comprise poly(acrylic), poly(methacrylics), poly(vinyl ether), poly(vinyl ester), polystyrene, polyurethane, polyoxide, polycarbonate, cellulose ester, cellulose ether, polyester, vinyl pyrrolidone copolymers like alkyl grafted PVP (Ganex®/Agrimer® AL 30, 22, 25, WP 660) Agrimer® VA (PVP-vinyl acetate copolymers), alkylated polyvinylpyrrolidone-hexadecane copolymer, polydiemethyl silane, beeswax and alkyl vinyl ether-maleic acid half-ester polymers, polyvinyl alkyl ether, polyactylate-polyoctylacrylamide copolymer (Dermacryl-79 and Dermacryl LT), a copolymer of a vinyl alkyl ether with vinyl acetate or vinyl chloride, methylcellulose, cellulose acetate, cellulose acetate butyrate, cellulose acetate phthalate, polyvinyl butyral, polyvinyl acetate, polymethyl methacrylate and polystyrene, vinyl homopolymers, acrylate homopolymers, styrene/butadiene copolymers, stryene/acrylate copolymers, or styrene/butadiene/acrylate copolymers, an acrylate ester polymer for example a homopolymer or copolymer of one or more alkyl acrylates or methacrylates which preferably contain 1 to 6 carbon atoms in the alkyl group and may contain a co-monomer such as acrylonitrile or styrene, or a vinyl acetate polymer such as polyvinyl acetate or a vinyl acetate vinyl chloride copolymer.

An alternative embodiment of the invention is to disperse the biocide encapsulated inert carrier in an aqueous or solvent medium in the presence of a suitable dispersing agent added during the coating step of the process. The safeguarding of the biocidal dispersion composition comprising biocide adsorbed inert carrier particles having a particle size of about 0.5 μm to 30 μm is feasible only through the presence of a dispersing or anti-settling or deflocculant agent and wherein it provides the continuous dispersion of inert carrier particles. Particularly, a dispersing agent is added to the composition to reduce or prevent the flocculation of biocide adsorbed inert carrier particles. The flocculation is the process wherein a plurality of inert carrier particles forms agglomerate. Also, the added dispersing agent prevents the sedimentation of the biocide adsorbed inert carrier particles in the composition and thus leads to poor product quality, performance and efficiency when used in any specific application.

Suitable dispersing agent may be employed for the preparation of aqueous biocidal dispersion, for example, cationic, amphoteric or nonionic compounds alone or in combinations thereof; however they are not limited to the dispersants that are described herein. Suitable examples are for instance described in C. R. Martens, Emulsion and Water-Soluble Paints and Coatings, Reinhold Publishing Corporation, 1965. More particularly, the dispersants are selected from group consisting of tetra-potassium pyrophosphate or “TKPP” compounds such as Strodex™, Strodex™ PK-90, Strodex™ PK-0VOC, Strodex™ MOK-70 manufactured by Dexter Chemical L.L.C. In some cases, a dispersant may be a particulate material supplied with trade name of Winnofil® SPT Premium, Winnofil® S, Winnofil® SPM, and Winnofil® SPT by Solvay Advanced Functional Minerals. A variety of preparations of customized montmorillonite clay (Bentone®) and castor wax under various trade names Crayvallac® SF, Crayvallac® MT, and Crayvallac®, AntiSettle CVP by Cray Valley Limited are also known as a dispersant in the prior art.

Still more particularly, the dispersing agents also selected from standard organic polymeric dispersants that are known in the art for preparing biocidal dispersion compositions and suitable dispersing agent would be readily available to a person skilled in the art. For illustration, the dispersants may be selected from polyelectrolytes such as polyacrylates and copolymers having polyacrylate compounds, for example various salts of polyacrylic acid compounds, sodium hexametaphosphates, polyphosphoric acid, condensed form of sodium phosphate, alkanolamines, and other reagents commonly used for this function. Additional examples of suitable dispersants would include sodium silicate, sodium carbonate, lignosulphonic acid salts (e.g., Polyfon, Ufoxane or Marsperse), a sulfonated naphthalene/formaldehyde condensate (e.g., Morwet), a block copolymer with pigment affinic group (e.g., Disperbyck 190), 1,4 bis(2-ethylhexyl)sodiumsulfosuccinate (e.g., Triton GR PG 70), Polyether-polycarbonate sodium salt (e.g., Ethacryl P), maleic acid-olefin co-polymer (e.g., Vultamol NN 4501), ammonium polyacrylate (e.g., Dispex GA 40), C₆-C₁₅ secondary alcohol and alkyl aryl sulfonate (e.g., Zetasperse 2300) and alkyl naphthalene sulfonate (e.g., Agnique), henolsulphonic or naphthalenesulphonic acid salts, 2-amino-2-methyl-1-propanol, tri and tetra sodium salts of pyrophosphate and polyphosphate and water-soluble sodium or ammonium salts of polyacrylates, polycarboxylates and polymethacrylates. Exceptional dispersing agents include poly(methylvinyl ether-co-maleic acid) partially neutralized with sodium hydroxide (EasySperse, EasySperse P20 by ISP, Wayne NJ) and non-ionic copolymers including but are not limited to EO/PO block copolymers or poloxamers such as Pluronics from BASF, polymers of acrylic and methacrylic acid, C₁₁-C₁₅ secondary ethoxylated alcohols and diols, PEG-PLGA-PEG copolymers and polyether polyols.

An additional embodiment of the present invention is to provide a uniform biocidal dispersion system wherein the encapsulated biocide comprising partial amount of non-encapsulated biocide, if any, are dispersed uniformly within the system, achieved by re-dispersing the acquired dispersion system with a suitable thickening agent. These thickeners can be helpful to enhance the viscosity of dispersion without modifying its original properties. Further, they help to increase the stability, improve the suspension of integrated ingredients of the dispersion system. Various hydrocolloid gums employed include Xanthan gum, guar gum, gellan gum, locust bean gum, gum Arabic, alginates, etc. are used to impart thixotropic properties to the present dispersion system. In some embodiments, cellulose thickener is employed, which is a polysaccharide having anhydroglucose units are further connected by an oxygen molecule to form a long molecular chains, has the ability to increase the density or viscosity of the dispersion in which it is integrated. Various cellulose thickener employed in the present disclosure would include but are not limited to hydroxypropyl cellulose, hydroxyethyl cellulose, hydroxypropylmethyl cellulose, ethyl hydroxyethyl cellulose, methyl ethyl hydroxyethyl cellulose, hydroxymethyl cellulose, hydroxyethylmethyl cellulose, carboxymethyl cellulose, sodium carboxymethyl cellulose, microcrystalline cellulose, alone or in combinations thereof. Apart from this, hydrophilically modified ethoxylated urethane (REUR), the hydrophobically modified ethoxylated urethane alkali swellable emulsions (HEURASE) are also optionally employed according to the requirement.

For example, suitable commercial thickeners include but are not limited to Xanthan Gum® (Kelzan® from Kelco), Rhodopol®23 (Rhone Poulenc) or Veegum® (from R.T. Vanderbilt), organic phyllosilicates (Attaclay® Engelhardt), HASE Thickener (RHEOLATE 425), ALCOGUM™ VEP-II (Alco Chemical Corporation), RHEO VIS™ and VISCALEX™ (Ciba Ceigy), UCAR®, ETHOCEL™ or METHOCEL™ (The Dow Chemical Company) and PARAGUM™ 241 (Para-Chem Southern, Inc.), or BERMACOL™ (Akzo Nobel) or AQUALON™ (Hercules) or ACUSOL® (Rohm and Haas). The hydrophobically modified ethoxylated urethane (HEUR) thickeners such as Acrysol RM 1020, Acrysol RM2020 and Acrysol RM5000 available from Rohm and Haas. Various other HEUR thickener would include Borchi Gel 0434, Borchi Gel 0435 and Borchi Gel 0011, Borchi Gel 0620, Borchi Gel 0621, Borchi Gel 0622, Borchi Gel 0625, Borchi Gel 0626, Borchi Gel PW 25, Borchi Gel LW44, Borchi Gel 0024, Borchi Gel WN50S, Borchi Gel L75N, Borchi Gel L76 from Borchers. Acrysol SCT-275, Acrysol RM8, Acrysol RM 825, Acrysol RM 895 (Rohm and Haas), Tafigel PUR 40, Tafigel PUR 41, Tafigel PUR 50, Tafigel PUR 60 Tafigel PUR 61 from Munzig, UCAR DR-73 from Rohm and Haas, Acrysol TT615 available from Rohm and Haas, Aquaflow ALS 400 from Aqualon. The hydrophobically modified polyacetal polyether Aquaflow NLS 200, Aquaflow NLS 205, and Aquaflow NLS 210 available from Aqualon/Hercules.

Optionally embodiments of the compositions of the present invention include further additives. These additives may be employed in the present biocidal dispersion system comprising biocide encapsulated or adsorbed inert carrier particles. Exemplary additives include, but are not limited to, stabilizing agent, filler, wetting agent, surfactants, anti-static agents, antifoam agent, anti block, wax-dispersion pigments, a neutralizing agent, a compatibilizer, a brightener, a rheology modifier, UV stabilizer, a coefficient of friction modifier, and other additives known to those skilled in the art.

The sustained-release stable biocidal compositions of the present invention can be employed in the following non-limiting applications such as agriculture, health, pharmaceutical, paint, metal-working fluids, homecare and/or personal care products.

One important aspect of the present invention is to provide a process for the preparation of sustained-release stable biocidal composition containing a blend of microencapsulated biocides comprising the steps of (i) adsorbing a first biocide onto a first inert carrier by grinding and wherein, the ratio of biocide:inert carrier is from about 1:99 to about 99:1; (ii) adsorbing a second biocide onto a second inert carrier by grinding and wherein, the ratio of biocide:inert carrier is from about 1:99 to about 99:1; (iii) commingling the encapsulated biocides obtained in step (i) and (ii); (iv) optionally, coating the commingled encapsulated biocide obtained in step (iii) with appropriate amine, imine compounds or water resistance film forming polymers to provide resistant to hydrolysis sensitive biocide which are adsorbed onto an inert carrier; (v) dispersing the resultant commingled encapsulated biocides in a suitable medium in the presence of appropriate dispersing agent; and (vi) adding at least one thickening agent to re-disperse the commingled encapsulated biocide containing partial amount of non-encapsulated biocide if any. In a preferred embodiment the first biocide, second biocide, first inert carrier and second inert carrier belong to two different chemical categories and two different sources.

The preparation of blend of independently encapsulated biocides according to the above process leads to competitive adsorption/desorption or adhesion/de-adhesion that would enable one to tailor the control-release or sustained-release of selected biocides preferably over the other in a given blend comprising mixture of many independently encapsulated biocides.

Further, the present invention is illustrated in detail by way of the below given examples. The examples are given herein for illustration of the invention and are not intended to be limiting thereof.

### Example 1

### IPBC Encapsulated Perlite (4:1)

Two hundred grams of IPBC (ISP) and 50 grams of perlite (Grade #1, Silbrico Corporation) were ground to powder by powder grinding machine for 30 min. The particle size distribution of the resultant powder was measured by a Malvern Mastersizer S instrument. The results signify that the d₁₀, d₅₀ and d₉₀ particle sizes were 0.2 μm, 0.6 μm and 8.0 μm respectively.

### Example 2

### IPBC Encapsulated Perlite (2:1)

Two hundred grams of IPBC (ISP) and 100 grams of perlite (Grade #1, Silbrico Corporation) were ground to powder by powder grinding machine for 30 min. The particle size distribution of the resultant powder was measured by a Malvern Mastersizer S instrument. The results signify that the d₁₀, d₅₀ and d₉₀ particle sizes were 0.2 μm, 0.4 μm and 8.0 μm respectively.

### Example 3

### IPBC Encapsulated Perlite (1:1)

Two hundred grams of IPBC (TSP) and 200 grams of perlite (Grade #1, Silbrico Corporation) were ground to powder by powder grinding machine for 30 min. The particle size distribution of the resultant powder was measured by a Malvern Mastersizer S instrument. The results signify that the d₁₀, d₅₀ and d₉₀ particle sizes were 0.2 nm, 0.6 μm and 8.0 μm respectively.

### Example 4

### Diuron Encapsulated Perlite (2:1)

Two hundred grams of Diuron and 100 grams of perlite (Grade 41, Silbrico Corporation) were ground to powder by powder grinding machine for 30 min. The particle size distribution of the resultant powder was measured by a Malvern Mastersizer S instrument. The results signify that the d₁₀, d₅₀ and d₉₀ particle sizes were 0.2 μm, 0.6 μm and 8.0 μm respectively.

### Example 5

### BIT Encapsulated Perlite (3:1)

Seven hundred and fifty grams of BIT and 250 grams of perlite (Grade #1, Silbrico Corporation) were ground to powder by powder grinding machine for 30 min. The particle size distribution of the resultant powder was measured by a Malvern Mastersizer S instrument. The results indicate that the d₁₀, d₅₀ and d₉₀ particle sizes were 0.2 μm, 0.6 μm and 8.0 μm respectively.

### Example 6

### BIT:AgNO₃ Encapsulated Perlite (3:0:0.6:1)

Prepare 200 grams of composition given in Example 5. Dissolve 1.7 grams of AgNO₃ (0.6% Ag⁺) in water or suitable solvent. Add the dissolved AgNO₃ into the mixture and comingle it to have a uniform composition.

### Example 7

### Terbutryn Encapsulated Perlite (4:1)

Two hundred grams of Terbutlyn and 50 grams of perlite (Grade #1, Silbrico Corporation) were ground to powder by powder grinding machine for 30 min. The particle size distribution of the resultant powder was measured by a Malvern Mastersizer S instrument. The results show that the d₁₀, d₅₀ and d₉₀ particle sizes were 0.2 μm, 0.6 μm and 8.0 μm respectively.

### Example 8

### Terbutryn Encapsulated Perlite (2:1)

Two hundred grams of Terbutryn and 100 grams of perlite (Grade #1, Silbrico Corporation) were ground to powder by powder grinding machine for 30 min. The particle size distribution of the resultant powder was measured by a Malvern Mastersizer S instrument. The results show that the d₁₀, d₅₀ and d₉₀ particle sizes were 0.2 μm, 0.6 μm and 8.0 μm respectively.

### Example 9

### Terbutryn Encapsulated Perlite (1:1)

Two hundred grams of Terbutryn and 200 grams of perlite (Grade #1, Silbrico Corporation) were ground to powder by powder grinding machine for 30 min. The particle size distribution of the resultant powder was measured by a Malvern Mastersizer S instrument. The results denote that the d₁₀, d₅₀ and d₉₀ particle sizes were 0.2 μm, 0.6 μm and 8.0 μm respectively.

### Example 10

### Terbutryn Encapsulated Bentonite (4:1)

Two hundred grams of Terbutryn and 50 grams of Bentonite (Grade #1, Silbrico Corporation) were ground to powder by powder grinding machine for 30 min. The particle size distribution of the resultant powder was measured by a Malvern Mastersizer S instrument. The results show that the d₁₀, d₅₀ and d₉₀ particle sizes were 0.2 μm, 0.6 μm and 8.0 μm respectively.

### Example 11

### Terbutryn Encapsulated Bentonite (2:1)

Two hundred grams of Terbutryn and 100 grams of Bentonite (Grade #1, Silbrico Corporation) were ground to powder by powder grinding machine for 30 min. The particle size distribution of the resultant powder was measured by a Malvern Mastersizer S instrument. The results show that the d₁₀, d₅₀ and d₉₀ particle sizes were 0.2 μm, 0.6 μm and 8.0 μm respectively.

### Example 12

### Terbutryn Encapsulated Bentonite (1:1)

Two hundred grams of Terbutryn and 200 grams of Bentonite (Grade #1, Silbrico Corporation) were ground to powder by powder grinding machine for 30 min. The particle size distribution of the resultant powder was measured by a Malvern Mastersizer S instrument. The results denote that the d₁₀, d₅₀ and d₉₀ particle sizes were 0.2 μm, 0.6 μm and 8.0 μm respectively.

### Example 13

### Terbutryn Encapsulated Claytone (4:1)

Two hundred grams of Terbutryn and 50 grams of Claytone (Grade #1, Silbrico Corporation) were ground to powder by powder grinding machine for 30 min. The particle size distribution of the resultant powder was measured by a Malvern Mastersizer S instrument. The results show that the d₁₀, d₅₀ and d₉₀ particle sizes were 0.2 μm, 0.6 μm and 8.0 μm respectively.

### Example 14

### Terbutryn Encapsulated Claytone (2:1)

Two hundred grams of Terbutryn and 100 grams of Claytone (Grade #1, Silbrico Corporation) were ground to powder by powder grinding machine for 30 min. The particle size distribution of the resultant powder was measured by a Malvern Mastersizer S instrument. The results show that the d₁₀, d₅₀ and d₉₀ particle sizes were 0.2 μm, 0.6 μm and 8.0 μm respectively.

### Example 15

### Terbutryn Encapsulated Claytone (1:1)

Two hundred grams of Terbutryn and 200 grams of Claytone (Grade #1, Silbrico Corporation) were ground to powder by powder grinding machine for 30 min. The particle size distribution of the resultant powder was measured by a Malvern Mastersizer S instrument. The results denote that the d₁₀, d₅₀ and d₉₀ particle sizes were 0.2 μm, 0.6 μm and 8.0 μm respectively.

### Example 16

### Terbutryn, IPBC and Folpet Encapsulated Perlite (2:1)

A combined mixture of two hundred grams of 3 different biocides and 100 grams of perlite (Grade #1, Silbrico Corporation) were ground to powder by powder grinding machine for 30 min and wherein the ratio of biocides is 3:6:1, particularly, 60 gms of Terbutryn, 120 gms of IPBC and 20 gms of Folpet. The particle size distribution of the resultant powder was measured by a Malvern Mastersizer S instrument. The results show that the d₁₀, d₅₀ and d₉₀ particle sizes were 0.2 μm, 0.6 μm and 8.0 μm respectively.

### Example 17

### Diuron/IPBC Encapsulated Perlite (2:1)

A combined mixture of two hundred grams of two different biocides and 100 grains of perlite (Grade #1, Silbrico Corporation) were ground to powder by powder grinding machine for 30 min and wherein the ratio of biocides is 3:7, particularly, 60 gms of Diuron and 140 gms of IPBC. The particle size distribution of the resultant powder was measured by a Malvern Mastersizer S instrument. The results show that the d₁₀, d₅₀ and d₉₀ particle sizes were 0.6 μm and 8.0 μm respectively.

### Example 18

### Blend of (A) IPBC Encapsulated Perlite (2:1); and (B) Terbutryn Encapsulated Claytone (2:1)

The IPBC encapsulated perlite (A) and Terbutryn encapsulated claytone (B) is prepared independently according to preceding Examples 2 and 14. Further, the encapsulated IPBC and Terbutryn (A and B) are commingled to obtain a blend of multiple encapsulated biocide matrices.

### Example 19

### Preparation of Aqueous Biocidal Dispersion

The encapsulated biocides prepared according to the examples 1-6 were further formulated as water based dispersions. The formulations in suitable ranges include:

1. 0-60% of encapsulated active;

2. 0-5% Titania;

3. 0-5% polymeric dispersants;

4. 0-5% monomeric dispersant;

5. 0-5% or 0-1% thickener;

6. 0-1% defoamer; and

7. Quantity sufficient to make up the volume with water up to 100%.

General Procedure: In a vessel with a cowls mixer added about 80% of the water required, the wetting agent, dispersant, titania, and encapsulated biocide. The ingredients are mixed thoroughly at 500 rpm for 30 min. The defoamer and thickener were added with the remaining water and mixed at 2000 rpm for an additional 30 min of duration. The charge was pumped to a basket mill and milled to the selected particle size usually Hegman grind 6-7.

### Example 20

### Preparation of a Solvent Based Dispersion

The encapsulated biocides prepared according to examples 1-6 were further formulated as water based dispersions. The formulations in suitable ranges include:

1. 0-60% of encapsulated active;

2. 0-5% Titania;

3. 0-5% polymeric dispersants;

4. 0-5% monomeric dispersant;

5. 0-5% or 0-1% thickener;

6. 0-1% defoamer; and

7. Quantity sufficient to make up the volume with a suitable solvent up to 100%.

General Procedure: In a vessel with a cowls mixer added about 80% of the solvent required, the wetting agent, dispersant, titania, and encapsulated biocide. The ingredients are mixed thoroughly at 500 rpm for 30 min. The defoamer and thickener were added with the remaining solvent and mixed at 2000 rpm for an additional 30 min of duration. The charge was pumped to a basket mill and milled to the selected particle size usually Hegman grind 6-7.

### Example 21

### Evaluation of Leaching Ability by Antifungal Activity of IPBC (20%):Perlite (2:1)

The aqueous biocidal dispersion containing encapsulated biocide was formulated as described in example 19 to provide 20% of IPBC as active ingredient in a ratio of 2:1 with perlite which is prepared according to the Example 2.

The aqueous biocidal dispersion containing encapsulated biocide was added to a standard PVA paint at 0.1% by wt. Fungitrol 420S (20% IPBC in solution) was added at 0.1% as a control. Drawdown of the paint samples were prepared by casting a 3-mil film onto drawdown paperboard (Lanetta). The drawdown samples were allowed to dry at room temperature for 24 hrs. Strips were cut from each drawdown sample and leached with distilled water at a flow rate of six exchanges for 24, 48 and 72 hrs, followed by drying at room temperature for 24 hours.

One inch squares were cut from each strip and placed painted-side-up on solidified malt agar. The plates were inoculated with 1.0 mL of a mixed fungal suspension consisting of Aspergillus niger (ATCC 6275) and Penicillium funiculosum (ATCC 11797), each with a concentration of about 107 spores/mL. The plates were incubated at 28° C. and 85% RH for 7 days.

A zone growth inhibition was measured around the sample. The zone of inhibition will correlate to the concentration of IPBC in the sample. The larger zone of inhibition after extensive leaching of 72 hrs demonstrates the consistent control release of IPBC into the wash water. The results are disclosed in Table 1.

TABLE 1
Zone of inhibition (mm) after 7 days

| | Leaching | | |
|---|---|---|---|
| Aqueous Dispersion/Control | 24 hrs | 48 hrs | 72 hrs |
| Control (Absence of biocide) | 0 | 0 | 0 |
| 20% IPBC (1:1 perlite) (2,000 ppm IPBC) | 12 | 7 | 4 |
| 20% IPBC (Fungitrol 420S) (2,000 ppm | 9 | 3 | 0 |
| IPBC) | | | |

### Example 22

### Evaluation of Leaching Ability by Antifungal Activity IPBC (0.05%):Perlite (2:1)

Samples were prepared in the same fashion as in Example 9 except that 0.05% IPBC was added into the samples. The ratio of IPBC/Perlite was 2:1.

The plates were incubated at 28° C. and 85% RH for 28 days. Fungal growth was rated on the surface of the painted sample as indicated in ASTM D5590 on a scale from 0-4 where “0” represents no growth; 1 represents traces of growth (<10%); 2 represents light growth (10-30%); 3 represents moderate growth (30-60%) and 4 represents heavy growth (60% to complete coverage). As shown in Table 2 the encapsulated biocide provided longer lasting protection on the surface of the sample (0 rating) after extensive leaching.

TABLE 2
Growth ratings on the surface of the sample after 28 days

| | Leaching | | | |
|---|---|---|---|---|
| | | | | 96 |
| Aqueous Dispersion/Control | 0 hrs | 48 hrs | 72 hrs | hrs |
| Control (Absence of biocide) | 4 | 4 | 4 | 4 |
| 20% IPBC (2:1 perlite) (500 ppm IPBC) | 0 | 0 | 0 | 0 |
| 20% IPBC (Fungitrol 420S) (500 ppm) | 0 | 2 | 4 | 4 |

### Example 23

### Evaluation of Leaching Ability by Antibacterial Activity of BIT (20%):Perlite

The aqueous biocidal dispersion containing encapsulated biocide was prepared as described in example 19 to provide 20% BIT (prepared as described in Example 5). The dispersion was incorporated into flexible PVC using a Brabender. The plastic samples containing different BIT concentrations were tested according to the Japanese HS Z 2801:2000 entitled “Antimicrobial products-test for antimicrobial activity and efficacy.”

Briefly, samples were inoculated on the surface with bacterial strains such as Escherichia coli ATCC 11229 or Staphylococcus aureus ATCC 6538. After 24 hrs of incusbation, the samples were examined to determine the number of bacterial count left on the surface of the sample. A reduction in the bacterial population or count was estimated based on the plate count of the control (untreated or blank) sample and treated samples. The results of this activity indicate that aqueous biocidal dispersion prepared according to the present invention provides better antibacterial activity through larger log reduction and is shown in Table 3.

TABLE 3
Antimicrobial Activity (Log Reduction)

| | |
|---|---|
| E. coli | S. aureus |

| ppm | BIT | BIT-Perlite | BIT | BIT-perlite |
|---|---|---|---|---|
| 100 | 0.9 | 1.3 | 0.2 | 0.6 |
| 250 | 2.5 | 3.6 | 0.6 | 1.6 |

### Example 24

### Analytical Determinations of Active Ingredients in the Leachate

The active ingredient is added (5%) to required amount of water. After a certain amount of time, the leachate is collected through a filter and the same amount of water replaced. The amount of active ingredients of each leachate is determined analytically by UV-Vis. Table 4 shows differences in the IPBC recovered in encapsulated vs. non-encapsulated samples. Table 5 shows the differences in the Terbutryn recovered in encapsulated vs. non-encapsulated samples and Table 6 shows differences in Diuon recovered in encapsulated vs. non-encapsulated samples.

TABLE 4
The amount of IPBC (in ppm) present in leached water, the difference
between leaching of non-encapsulated IPBC and
encapsulated IPBC in different time intervals

| | | | IPBC in water |
|---|---|---|---|
| Type of Sample | Leaching Time | | (in ppm) |
| Non-encapsulated IPBC | 5 | minutes | 356 ± 4 |
| | 1 | hr | 273 ± 10 |
| | 24 | hrs | 236 ± 22 |
| Encapsulated IPBC | 5 | minutes | 324 ± 30 |
| (Example 2) | 1 | hr | 105 ± 7 |
| | 24 | hrs | 175 ± 4 |
| Perlite | 24 | hrs | 0 |

TABLE 5
The amount of Terbutryn (in ppm) present in leached water, the
difference between leaching of non-encapsulated Terbutryn and
encapsulated Terbutryn in different time intervals

| | | | Terbutryn in water |
|---|---|---|---|
| Type of Sample | Leaching Time | | (in ppm) |
| Non-encapsulated Terbutryn | 5 | minutes | 150 |
| | 1 | hr | 90 |
| | 24 | hrs | 79.8 |
| Encapsulated Terbutryn | 5 | minutes | 65.3 |
| (Example 8) | 1 | hr | 60.0 |
| | 24 | hrs | 52.0 |

TABLE 6
The amount of Diuron (in ppm) present in leached water, the difference
between leaching of non-encapsulated Diuron and
encapsulated Diuron in different time intervals

| | | | Diuron in water |
|---|---|---|---|
| Type of Sample | Leaching Time | | (in ppm) |
| Non-encapsulated Diuron | 30 | minutes | 53.6 |
| | 2 | hrs | 51.4 |
| | 4 | hrs | 54.6 |
| | 20 | hrs | 52.0 |
| Encapsulated Diuron (Example 4) | 30 | minutes | 44.0 |
| | 2 | hrs | 41.5 |
| | 4 | hrs | 44.8 |
| | 20 | hrs | 39.5 |

### Example 25

### Analytical Determinations of Active Ingredient Leaching Out of a Paint Film

The active ingredient is added to PVA paint to a final concentration of 2000 ppm. Drawdown of the paint samples are prepared by casting a 3-mil film onto drawdown paperboard (Lanetta). The drawdown samples are allowed to dry at room temperature for 24 hrs. A sample of 2×6 cm is cut. The cut samples are then placed in 100 ml of water in a closed beaker for the different duration of time limits. At different time intervals the water is collected and replaced with the same amount of water. The quantity of the active ingredient present in each leachate is determined by UV-Visible spectroscopic method. Table 7 shows the results of amount of IPBC (in ppm) collected in the leachate from paint films in the presence of non-encapsulated IPBC and encapsulated IPBC at different time intervals.

TABLE 7
The amount of IPBC (in ppm) leached from paint films drawn from
non-encapsulated IPBC and encapsulated IPBC in different time
intervals (total IPBC incorporated 2000 ppm)

| | | | IPBC (in ppm) leached |
|---|---|---|---|
| Type of Sample | Leaching Time | | from Paint film |
| Non-encapsulated IPBC | 1 | hr | 1050 |
| | 3 | hrs | 102 |
| | 15 | hrs | 65 |
| | 48 | hrs | 78 |
| Encapsulated IPBC (Example 2) | 1 | hr | 832 |
| | 3 | hrs | 141 |
| | 15 | hrs | 64 |
| | 48 | hrs | 3.2 |

While the foregoing written description of the invention enables one of ordinary skill to make and use what is considered presently to be the best mode thereof; those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

What is claimed is:

1. A process for the preparation of a sustained-release stable biocidal composition containing a microencapsulated biocide comprising the steps of:
i. adsorbing a biocide onto an inert carrier by grinding and wherein the ratio of biocide:inert carrier is from about 1:99 to about 99:1;
ii. optionally, coating with an appropriate amine or imine compound or a water resistant film forming polymer;
iii. dispersing the resultant biocide encapsulated inert carrier in a suitable medium in the presence of an appropriate dispersing agent; and
iv. adding at least one thickening agent to re-disperse the encapsulated biocide.

2. The process according to claim 1, wherein the medium is aqueous or solvent selected from the group consisting of polyglycol, polyether, polyol, mineral oil, plasticizer pthalates and/or alkyd resins.

3. The process according to claim 1, comprising one or more biocides alone or appropriate mixtures thereof.

4. The process according claim 1, wherein said inert carrier is selected from the group consisting of modified or non-modified forms of silicates, aluminosilicates, expanded perlite, bentonite, claytone, zeolite, kaolin or diatomaceous earth materials alone or in combination.

5. The process according to claim 1, wherein said amine or imine is selected from the group consisting of N,N-Dimethyl-1-octadecanamine, Armeen DMMCD, Armeen DMTD, Armeen DM12D, Armeen DM14D, Armeen DM16D, Armeen DM18D, Armeen DM22D, Armeen M2HT, Armeen M20, polyamine and/or polyimine.

6. A process according claim 1, wherein said dispersing agent is Easy Sperse P20 and/or EO/PO block copolymers, polymers of acrylic acids and methacrylic acid, C11-C15 secondary ethoxylated alcohols and dials, PEG-PLGA-PEG copolymers, polyethers polyols.

7. The process according to claim 1, wherein said water-resistant film forming polymer is selected from the group consisting of alkylated polyvinylpyrrolidone/hexadecane copolymers and/or polydimethyl silane.

8. The process according to claim 1, wherein said thickening agent is selected from the group consisting of hydrocolloid gums and cellulose derivatives, xanthan gum, guar gum and/or hydroxymethyl cellulose.

9. The process according to claim 1, wherein said biocide is sparingly water-soluble or water-insoluble and/or sensitive to hydrolysis.

10. A process according to claim 1, wherein said biocide is selected from the group consisting of 1,2-benzisothiazolin-3-one, 2-methyl-4-isothiazolin-3-one, 5-chloro-2-methyl-4-isothiazoline-3-one, 2-octyl-4-isothiazoline-3-one, 4,5-dichloro-2-octyl-4-isothiazoline-3-one, silver, 2-bromo-2-nitropropane-1,3-diol 3-iodo-2-propargyl butyl carbamate, trichloromethylthiophthalimide, tetrachloroisophthalo-nitrile, 2-tert-butylamino-4-ethylamino-6-methylmercapto-s-triazine, 2-(tert-Butylamino)-4-(cyclopropylamino)-6-(methylthio)-s-triazine, Methyl 1H-benzimidazol-2-ylcarbamate, N′-(3,4-diehlorophenyl)-N,N-dimethylurea, 1-[2(2,4-dichlorophenyl)-4-propyl-1,3-dioxolan-2-yl]methyl]1-H-1,2,4-triazole, α[2-(4-chlorophenyl)ethyl]-α-(1,1-dimethylethyl)-1H-1,2,4-triazole-1-ethanol.

11. The process according to claim 1, wherein said biocide is adsorbed onto an inert carrier in an amount of about 99 wt %.

12. A sustained-release stable biocidal composition containing microencapsulated biocide prepared by the process of claim 1 employed in the field of agriculture, health, pharmaceutical, paint, homecare, personal care products, metal working fluids, oilfield and wood treatment.

13. A stable, sustained-release aqueous or solvent biocidal composition comprising;
i. a biocide adsorbed onto an inert carrier, optionally coated with amine, imine or water resistant film forming polymer;
ii. a dispersant; and
iii. a thickening agent to re-disperse the encapsulated biocide/s containing non-encapsulated biocide/s if any.

14. A process for the preparation of a sustained-release, stable biocidal composition containing a blend of microencapsulated biocides comprising the steps of:
i. adsorbing a first biocide onto a first inert carrier by grinding and wherein, the ratio of biocide:inert carrier is from about 1:99 to about 99:1;
ii. adsorbing a second biocide onto a second inert carrier by grinding and wherein, the ratio of biocide:inert carrier is from about 1:99 to about 99:1;
iii. commingling the encapsulated biocides obtained in step (i) and (ii);
iv. optionally, coating the commingled encapsulated biocide obtained in step (iii) with appropriate amine, imine compounds or water resistant film forming polymers;
v. dispersing the resultant commingled encapsulated biocides in a suitable medium in the presence of appropriate dispersing agent; and
vi. adding at least one thickening agent to re-disperse the commingled encapsulated biocide.

15. The process according to claim 14, wherein said first and second biocides belong to two different chemical categories.

16. The process according to claim 14, wherein said first and second inert carriers belong to two different categories or sources.
